(19) United States
(12) Patent Application Publication
(10) Pub. No.: US 2026/0018817 A1
(43) Pub. Date: Jan. 15, 2026

(54) ELECTRICAL CONNECTOR ASSEMBLY

(71) Applicant: Molex, LLC, Lisle, IL (US)

(72) Inventors: Yun-Fang Yang, Shanghai (CN); De-Qian Lu, Shanghai (CN)

(21) Appl. No.: 19/258,957

(22) Filed: Jul. 3, 2025

(30) Foreign Application Priority Data
Jul. 10, 2024 (CN) 202410924664.0
Apr. 9, 2025 (CN) 202510442990.2

(51) Int. Cl. H01R 13/04; H01R 12/58; H01R 13/405; H01R 13/52

(52) U.S. Cl. CPC H01R 13/04; H01R 12/58; H01R 13/405; H01R 13/521

(57) ABSTRACT

An electrical connector assembly includes an insulative housing and a first electrical connector, a second electrical connector and a third electrical connector which are provided on the insulative housing; wherein the first electrical connector is provided with a plurality of conductive terminals, the third electrical connector is provided with a plurality of contacting terminals, each conductive terminal includes a main body and a first connecting portion, a second connecting portion and a third connecting portion which extend outwardly from the main body; wherein the first connecting portions of conductive terminals act as a first mating portion of the first electrical connector, the second connecting portions of the conductive terminals act as a second mating portion of the second electrical connector, and the third connecting portions of the conductive terminals are electrically connected respectively with the contacting terminals of the third electrical connector.

### TECHNICAL FIELD

The present disclosure relates to the technical field of electrical connectors, and specifically relates to an electrical connector assembly.

### BACKGROUND

With rapid development of electric bicycles, electric automobiles and other electric devices, applications of electrical connectors are increasingly wide in these devices. The electrical connector acts as a key electrical connecting component, performance of the electrical connector directly affects operating stability and safety of the entire device.

Chinese patent document CN217823441U discloses an electrical connector, which includes a female base and a male head, the female base includes a female base housing and clamping springs, the female base housing is provided with a female base square body, a front portion of the female base square body is provided with a female base square groove, the female base square body is provided with a plurality of clamping spring mounting grooves therein, the plurality of clamping spring mounting grooves are positioned in a rear portion of the female base square groove, each clamping spring mounting groove mounts one clamping spring therein, the male head includes a male head housing, a male head sealing ring, a pin mounting base and pins, the pin mounting base mounts the pins therein.

However, the pin and the clamping spring of the above electrical connector each only have two connecting portions which are respectively positioned at a front side and a rear side, which only can realize electrical connection between the male head and the female base, but cannot realize electrical connection with a third electrical connector (for example a vehicle control unit), and is not beneficial to miniaturization and multi-function of the device. Therefore, there still is room for an electrical connector assembly in structure compactness and convenience of manufacturing process.

### SUMMARY

In view of the above, the present disclosure provides an electrical connector assembly which is more compact in structure and is adapted to application situations where a space is constrained and which has a plurality of electrical connectors.

According to some embodiments, the present disclosure provides an electrical connector assembly comprising an insulative housing and a first electrical connector, a second electrical connector and a third electrical connector which are provided on the insulative housing; wherein the first electrical connector is provided with a plurality of conductive terminals, the third electrical connector is provided with a plurality of contacting terminals, each conductive terminal comprises a main body and a first connecting portion, a second connecting portion and a third connecting portion which extend outwardly from the main body; wherein the first connecting portions of the conductive terminals act as a first mating portion of the first electrical connector, the second connecting portions of the conductive terminals act as a second mating portion of the second electrical connector, and the third connecting portions of the conductive terminals are electrically connected respectively with the contacting terminals of the third electrical connector.

In the above embodiments, by that the first connecting portion, the second connecting portion and the third connecting portion are integrated to the same conductive terminal, an entire structure of the electrical connector assembly may be more compact. In comparison with the design of the traditional electrical connector assembly, the above embodiments may electrically connect the three connectors, which reduces the volume of the electrical connector assembly, and makes the electrical connector assembly more adapted to application situation where a space is constrained, for example electric bicycles and electric automobiles and the like. And in the above embodiments, a structure design of the single main body of the conductive terminal further reduces connected points between the terminals which are separated from each other and lowers risk of electrical fault due to poor contact. The design manner that the first connecting portion, the second connecting portion and the third connecting portion extend outwardly from the same main body is beneficial to enhance reliability and stability of the electrical connector assembly in use.

In some embodiments, the first connecting portion of the conductive terminal extends outwardly from the main body along a first direction, the second connecting portion extends outwardly from the main body along a second direction, the third connecting portion extends outwardly from the main body along a third direction; wherein any two directions of the first direction, the second direction and the third direction are perpendicular to each other.

In the above embodiments, the first connecting portion, the second connecting portion and the third connecting portion of the conductive terminal extend respectively along different directions, a space to be occupied may be effectively reduced, the structure of the electrical connector assembly is more compact. As such, not only adaptability of the electrical connector assembly in a small space is promoted, but also mounting and wiring of the electrical connector assembly is more convenient.

In some embodiments, each conductive terminal is formed by stamping and bending a metal sheet, the first connecting portions of the conductive terminals are arranged as three rows, the three rows comprises two first connecting portions which are respectively positioned at two sides and each are in form of flat plate shape and multiple first connecting portions which are positioned in a middle and each are in form of needle shape.

That the conductive terminal is formed by stamping and bending the metal sheet may promote producing efficiency and lower manufacturing cost. In the above embodiments, the first connecting portions are arranged as three rows, the two first connecting portions at the two sides each are in form of flat plate shape acting as a power terminal for transmission of high current, the first connecting portions in the middle each are in form of needle shape acting as a signal terminal for transmission of lower current, which may make a layout of the conductive terminals more compact, and thus sufficiently save a space.

In some embodiments, the third connecting portions of the conductive terminals are arranged as one row.

In the above embodiments, that the third connecting portions of the conductive terminals are arranged as one row may make the third connecting portions more conveniently connected to the contacting terminals of the third electrical connector. Such an arrangement manner further facilitates automatic fitting, is helpful to promote connecting efficiency, and lower labor cost.

In some embodiments, the insulative housing comprises a first side and a second side which are opposite to each other, the first electrical connector is provided to the first side of the insulative housing, the second electrical connector is provided to the second side of the insulative housing; the first connecting portion of the conductive terminal extends toward the first side of the insulative housing, and the second connecting portion extends toward the second side of the insulative housing.

In the above embodiments, by that the first electrical connector and the second electrical connector are respectively be provided to the two sides of the insulative housing and the first connecting portion and the second connecting portion of the conductive terminal respectively extend toward the corresponding sides of the insulative housing, reasonable space allocation may be realized, the entire electrical connector assembly is more compact.

In some embodiments, the electrical connector assembly further comprises a conductive structure; the contacting terminals of the third electrical connector are electrically connected with the third connecting portions of the conductive terminals in one-to-one correspondence via the conductive structure.

In the above embodiments, by that the conductive structure is additionally provided, the contacting terminals of the third electrical connector are electrically connected with the third connecting portions of the conductive terminals in one-to-one correspondence, which may ensure stability and reliability of an internal circuit of the electrical connectors. The conductive structure can provide one longer electrical connection path, so as to facilitate arrangement of the third electrical connector which is spaced farther away from the first electrical connector and the second electrical connector.

In some embodiments, the contacting terminal of the third electrical connector extends toward the first side of the insulative housing; the third connecting portion of the conductive terminal extends perpendicular to the first side and the second side.

The above embodiments further optimize an internal layout of the electrical connector assembly, reduce the entire thickness of the electrical connector assembly, and make the electrical connector assembly more adapted to the application situation where a space is constrained. At the same time, the above embodiments employ a design of extending perpendicularly is further beneficial to increase mechanical strength of connected points and promotes use reliability of the electrical connector assembly.

In some embodiments, the conductive structure is a plurality of metal busbars, a flexible circuit board or a printed circuit board; one end of the conductive structure is electrically connected to the third connecting portions of the conductive terminals, and the other end of the conductive structure is electrically connect to the contacting terminals of the third electrical connector.

In some embodiments, the insulative housing is formed by injection molding, the insulative housing fixes the plurality of contacting terminals and the plurality of conductive terminals thereon; the insulative housing forms a mating wall portion which corresponds to an outer periphery of the first connecting portions of the plurality of conductive terminals and protrudes toward the first side, and the insulative housing forms a plurality of positioning protrusions, which protrudes, at the second side.

In the above embodiments, by that the insulative housing, which is formed by injection molding, fixes the plurality of contacting terminals and the plurality of conductive terminals thereon, it not only may simplify manufacturing process and promote producing efficiency, but also may ensure structural stability and reliability of the electrical connector assembly. The insulative housing is formed with the mating wall portion which protrudes toward the first side and the plurality of positioning protrusions which protrude at the second side, which may facilitate smoothly mating with another mating electrical connector.

In some embodiments, the insulative housing is provided with a receiving cavity inside the mating wall portion, the receiving cavity is used to receive the first connecting portions of the conductive terminals; the insulative housing is provided with a sealing element which is used to seal gaps between the conductive terminals and the receiving cavity.

In the above embodiments, the sealing element may effectively prevent external circumstance factors, such as dust, water and the like, from invading, protecting internal structures of the electrical connector assembly, and prolong service life of the electrical connector assembly. At the same time, the design of the sealing element may further promote a protection level of the electrical connector assembly and enhance adaptability of the electrical connector assembly in a severe environment.

In some embodiments, the third connecting portions of the conductive terminals are electrically connected with the contacting terminals of the third electrical connector respectively via a circuit board.

In the above embodiments, the third connecting portion is realized to be electrically connected with the contacting terminal of the third electrical connector via the circuit board, which sufficiently utilizes conductive passageways and a wiring structure of the circuit board, makes the entire structure of the electrical connector assembly more compact, is helpful to reduce internal wiring length and space occupation, and thus further promote integration level. And, by means of wiring capability of the circuit board, the electrical connector assembly may further flexibly connect the third connecting portions with more third electrical connectors or other function module according to application requirement, so that expansion of more functions is realized to facilitate meeting working requirements in different application situations.

In some embodiments, the circuit board is a printed circuit board, a tail of each third connecting portion away from the main body is in form of needle shape; the printed circuit board is provided with a plurality of first conductive through holes; the tails of the third connecting portions correspondingly insert into the first conductive through holes of the printed circuit board.

In the above embodiments, the tail of the third connecting portion is designed as a needle shape and tightly fits with the first conductive through hole of the printed circuit board can provide higher connecting stability, prevent connection from being loosened, and thus ensure stable electrical connection over a long time. A connecting manner between the tail with the needle shape and the first conductive through hole makes fitting simpler and easily implemented, in comparison with laser welding, does not need high precision alignment and complex device, and is higher in efficiency, is beneficial to lower produce difficulty and promotes fitting efficiency.

In some embodiments, the first connecting portions of the conductive terminals are arranged as three rows, the three rows comprises two first connecting portions which are respectively positioned at two sides and each are in form of flat plate shape and multiple first connecting portions which are positioned in a middle and each are in form of needle shape; the second connecting portions of the conductive terminals each are in form of flat plate shape.

In the above embodiments, the first connecting portions of the conductive terminals are arranged as three rows, that the first connecting portions and the second connecting portions at the two sides each are designed as the flat plate shape facilitates meeting high current transmission requirement, that the first connecting portions in the middle each are designed as the needle shape is adapted to low current transmission. That different terminal shapes are combined as such not only makes the layout of the conductive terminals more compact, but also sufficiently saves space, and realizes high efficient space utilization.

In some embodiments, the third electrical connector comprises a mating housing, the contacting terminals are fixed in the mating housing; tail portions of the contacting terminals are correspondingly connected to the circuit board.

In some embodiments, the insulative housing is provided with a receiving groove; the third connecting portions of the conductive terminals are provided in the receiving groove, and the receiving groove is filled with a third sealing adhesive.

In some embodiments, the first side of the insulative housing is provided with a first electrical connector interface; the first connecting portions of the conductive terminals are provided in the first electrical connector interface, and the first electrical connector interface is filled with a first sealing adhesive therein.

In the above embodiments, by that the interface is filled therein with the sealing adhesive, tiny gaps between each connecting portion of the conductive terminal and the corresponding interface may be effectively filled to form additional waterproof barrier, which is helpful to further promote waterproof performance of the electrical connector assembly, ensures that the electrical connector assembly still can reliably operate in humid or underwater circumstance, so as to conform to higher level waterproof standard. And the process to fill the sealing adhesive is relatively simple, is easily implemented, and so does not bring negative effect on high producing efficiency or producing cost.

In some embodiments, the insulative housing is further provided with a second electrical connector interface at a second side which opposites a first side, and a sealing ring provided to the second electrical connector interface; the sealing ring is provided with a plurality of penetrating holes, the second connecting portions of the conductive terminals correspondingly insert into the penetrating holes.

In some embodiments, the sealing ring is formed on the insulative housing by injection molding.

In the above embodiments, the sealing ring is formed on the insulative housing by injection molding, such an integral molding manner can make the entire electrical connector assembly attain higher level waterproof standard, so that, even in severer humid circumstance or short-time immersion in water, the electrical connector assembly can reliably operate, effectively prevent electrical fault caused by moisture immersion, and guarantee safety and stability of the device. Traditional multi-molding process easily remains slits which form potential passageway for water immersion, but the injection molding manner can form continuous sealing interface without slit, which significantly lowers risk of water immersion and enhances reliability of waterproof. Moreover, that the sealing ring is formed on the insulative housing by injection molding further reduces risk that connection is unstable or waterproof performance is lowered due to detaching of the sealing ring.

In other embodiments, an outer edge of the second electrical connector interface is provided with an inserting groove; a side of the sealing ring toward the insulative housing is provided with at least one insertion protruding portion, the insertion protruding portion inserts into the inserting groove, so that the sealing ring is fixed on the second electrical connector interface.

The above embodiments provide a mounting-type sealing ring design, by inserting fixing between the insertion protruding portion and the inserting groove, the sealing ring is fixed on the insulative housing, to ensure that the sealing ring is not detached from the insulative housing over a long-time use. In comparison with implementing manner of injection molding, the above embodiments further can simplify manufacturing process and is beneficial to lower producing cost.

### BRIEF DESCRIPTION OF THE DRAWINGS

Other features, objects, and advantages of the present disclosure will become more apparent by reading the detailed description of non-limiting embodiments with reference to the accompanying drawings.

FIG. 1 and FIG. 2 are perspective structure schematic views of an electrical connector assembly of a first embodiment of the present disclosure;

FIG. 3 is a top view of the electrical connector assembly of FIG. 1

FIG. 4 is a cross-sectional view taken along a line A-A of FIG. 3;

FIG. 5 is a bottom view of the electrical connector assembly of FIG. 1;

FIG. 6 to FIG. 8 are perspective electrical connecting structure views of conductive terminals and contacting terminals in the electrical connector assembly of the first embodiment of the present disclosure;

FIG. 9 is a perspective structure view of the conductive terminals;

FIG. 10 and FIG. 11 are schematic views of the conductive terminals, in which a first connecting portion is in form of flat plate shape, in the electrical connector assembly of the first embodiment of the present disclosure;

FIG. 12 and FIG. 13 are schematic views of the conductive terminals, in which the first connecting portion is a connecting post in form of needle shape, in the electrical connector assembly of the first embodiment of the present disclosure;

FIG. 14 and FIG. 15 are perspective structure schematic views of a first molding body in the electrical connector assembly of the first embodiment of the present disclosure;

FIG. 16 and FIG. 17 are perspective structure schematic views of a second molding body in the electrical connector assembly of the first embodiment of the present disclosure;

FIG. 18 and FIG. 19 are perspective structure schematic views that the conductive terminals engage with the first molding body in the electrical connector assembly of the first embodiment of the present disclosure;

FIG. 20 and FIG. 21 are perspective structure schematic views of a sealing element in the electrical connector assembly of the first embodiment of the present disclosure;

FIG. 22 is a perspective structure schematic view of metal busbars in the electrical connector assembly of the first embodiment of the present disclosure without connecting parts between metal busbars removed;

FIG. 23 is a top view of the conductive terminals and the metal busbars with the connecting parts between the metal busbars removed;

FIG. 24 is a bottom view of the conductive terminals and the metal busbar without the connecting parts between the metal busbars removed;

FIG. 25 is a front view of a first electrical connector in the electrical connector assembly of the first embodiment of the present disclosure;

FIG. 26 is a front view of a second electrical connector in the electrical connector assembly of the first embodiment of the present disclosure;

FIG. 27 is a front view of a third electrical connector in the electrical connector assembly of the first embodiment of the present disclosure;

FIG. 28 is an electrically connecting schematic view of each connecting portion in the electrical connector assembly of the first embodiment of the present disclosure;

FIG. 29 is a perspective structure schematic view of the contacting terminals in the electrical connector assembly of the first embodiment of the present disclosure;

FIG. 30 is a perspective structure schematic view of an electrical connector assembly of a second embodiment of the present disclosure;

FIG. 31 is a top view of the electrical connector assembly of FIG. 30;

FIG. 32 is a bottom view of the electrical connector assembly of FIG. 30;

FIG. 33 is a cross-sectional view taken along line B-B of FIG. 31;

FIG. 34 is an exploded view of the electrical connector assembly of FIG. 30 viewed from a first angle;

FIG. 35 is an exploded view of the electrical connector assembly of FIG. 30 viewed from a second angle;

FIG. 36 is a perspective structure view of a printed circuit board in the electrical connector assembly of the second embodiment of the present disclosure;

FIG. 37 is a perspective structure view of conductive terminals in the electrical connector assembly of the second embodiment of the present disclosure;

FIG. 38 is a perspective structure view of the conductive terminals and the printed circuit board in the electrical connector assembly of the second embodiment of the present disclosure viewed from a first angle;

FIG. 39 is a perspective structure view of the conductive terminals and the printed circuit board in the electrical connector assembly of the second embodiment of the present disclosure viewed from a second angle;

FIG. 40 is a perspective structure view of a mating housing in the electrical connector assembly of the second embodiment of the present disclosure;

FIG. 41 is a perspective structure view of an insulative housing in the electrical connector assembly of the second embodiment of the present disclosure;

FIG. 42 is a perspective structure view of a sealing ring in the electrical connector assembly of the second embodiment of the present disclosure

FIG. 43 is a perspective structure view of the electrical connector assembly of the second embodiment of the present disclosure viewed from a first angle with another type of sealing ring assembled on the insulative housing being removed;

FIG. 44 is a perspective structure view of the electrical connector assembly of the second embodiment of the present disclosure viewed from a second angle with the insulative housing having a slight difference;

FIG. 45 is a perspective structure view of another type of sealing ring in the electrical connector assembly of the second embodiment of the present disclosure viewed from a first angle;

FIG. 46 is a perspective structure view of another type of sealing ring in the electrical connector assembly of the second embodiment of the present disclosure viewed from a second angle.

### DETAILED DESCRIPTION

In order to facilitate understanding of the present disclosure, the present disclosure will be more comprehensively described below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the disclosed content of the present disclosure more thorough and comprehensive.

Although the terms “up”, “down”, “between”, etc. may be used in this specification to describe different exemplary features and elements of the present disclosure, these terms are used only for convenience herein, for example, depending on the direction of the examples in the drawings. Any content in this specification should not be understood as requiring a specific three-dimensional orientation of the structure to fall within the scope of the present disclosure. And the illustrations provided in the embodiments only illustrate the basic concept of the present disclosure in a schematic manner. Although the illustrations only show the components related to the present disclosure and are not drawn according to the actual number, shape, and size of the components during implementation, the form, number, and proportion of each component during actual implementation can be arbitrarily changed, and the layout of the components may also be more complex.

The present disclosure provides an electrical connector assembly which is more compact in structure and is adapted to application situations where a space is constrained. Detailed content of the electrical connector assembly will be described in subsequent embodiments.

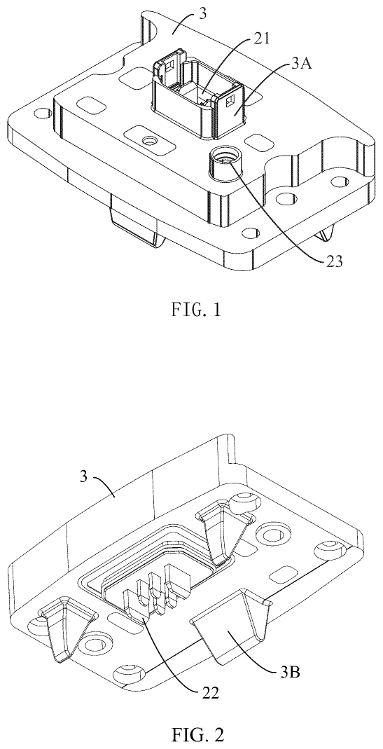

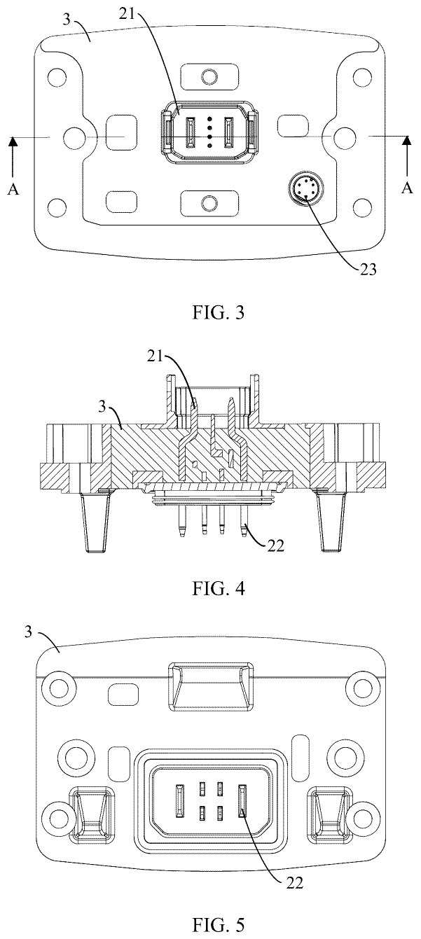

Hereinafter a first embodiment of the present disclosure will be understood with reference to FIG. 1 to FIG. 29.

Referring to FIG. 1 to FIG. 5, in some preferred examples, the electrical connector assembly specifically may include an insulative housing 3 and a first electrical connector 21, a second electrical connector 22 and a third electrical connector 23 which are provided on the insulative housing 3.

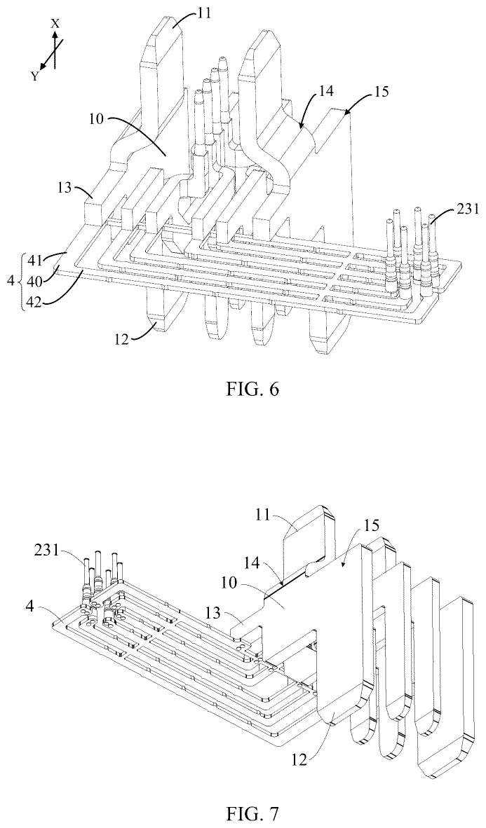

The first electrical connector 21 may be provided with a plurality of conductive terminals 1 as shown in FIG. 6 to FIG. 8, the third electrical connector 23 may is provided with a plurality of contacting terminals 231 as shown in FIG. 6 to FIG. 8. Each conductive terminal 1 specifically may include a main body 10 and a first connecting portion 11, a second connecting portion 12 and a third connecting portion 13 which extend outwardly from the main body 10.

Wherein, the first connecting portions 11 of the conductive terminals 1 may act as a first mating portion of the first electrical connector 21, the second connecting portions 12 of the conductive terminals 1 may act as a second mating portion of the second electrical connector 22, and the third connecting portions 13 of the conductive terminals 1 may be electrically connected with the contacting terminals 231 of the third electrical connector 23 respectively.

In the above electrical connector assembly, by that the conductive terminal 1 integrates the first connecting portion 11, the second connecting portion 12 and the third connecting portion 13 on the same main body 10, an entire structure of the electrical connector assembly may be more compact. A traditional electrical connector assembly generally includes a plurality of terminals which are separated from each other, the number of the terminals is large, which results in the electrical connector assembly to be complex in the entire structure and larger in volume. In comparison with the design of the traditional electrical connector assembly, the above embodiment reduces the volume of the electrical connector assembly, and makes the electrical connector assembly more adapted to application situations where a space is constrained, for example electric bicycles and electric automobiles and the like.

In the above electrical connector assembly, a structure design of the single main body 10 of the conductive terminal 1 further reduces connected points between the terminals which are separated from each other, and lowers risk of electrical fault due to poor contact. The design manner that the first connecting portion 11, the second connecting portion 12 and the third connecting portion 13 extend outwardly from the same main body 10 makes the connected points firmer, and is beneficial to enhance reliability and stability of the electrical connector assembly in use.

And, by that, the three connecting portions 11,12 and 13 are integrated on one main body 10, the conductive terminal 1 may electrically connect three different electrical connectors at the same time, assembling difficulty and time cost are lowered.

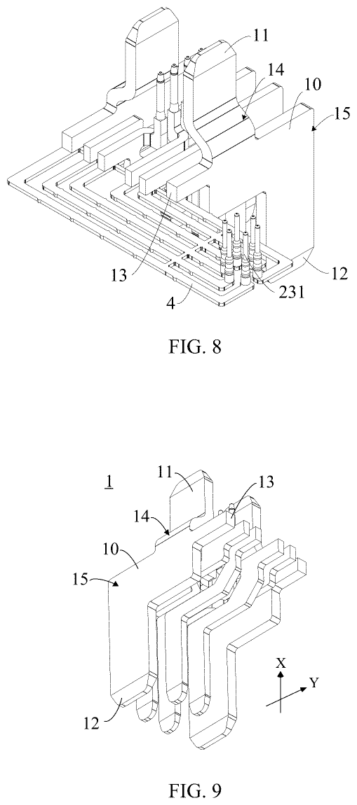

Exemplary, as shown in FIG. 9 to FIG. 13, the first connecting portion 11 may extend outwardly from the main body 10 along a first direction, the second connecting portion 12 may extend outwardly from the main body 10 along a second direction, and the third connecting portion 13 may extend outwardly from the main body 10 along a third direction.

Wherein, any two directions of the first direction, the second direction and the third direction are different from each other. Exemplary, the first direction may be a positive direction of an X direction as shown in FIG. 9 to FIG. 13, the second direction may be a negative direction of the X direction as shown in FIG. 9 to FIG. 13, and the third direction may be a Y direction as shown in FIG. 9 to FIG. 13.

In the above embodiment, the first connecting portion 11, the second connecting portion 12 and the third connecting portion 13 of the conductive terminal 1 extend respectively along different directions, as such, a space to be occupied may be effectively reduced, the structure of the electrical connector assembly is more compact. Not only is adaptability of the electrical connector assembly in a small space promoted, but also mounting and wiring of the electrical connector assembly is more convenient.

Exemplary, any two directions of the first direction, the second direction and the third direction are perpendicular to each other. To be arranged in perpendicular directions may increase isolation between different connected points, reduce signal interference, and promote working performance and stability of the electrical connector assembly.

Exemplary, as shown in FIG. 9 to FIG. 13, the conductive terminal 1 may further include a first bending portion 14 and a second bending portion 15.

In the electrical connector assembly provided by the above embodiment, the first connecting portion 11 is connected with the main body 10 via the first bending portion 14, and the second connecting portion 12 is connected with the main body 10 via the second bending portion 15.

In the electrical connector assembly provided by the above embodiment, that bending structures with respect to the first connecting portion 11 and the second connecting portion 12 are formed on the main body 10 makes distribution of the first connecting portion 11 and the second connecting portion 12 tight, significantly reduces the space occupied by the conductive terminal 1, is beneficial to miniaturization design of the electrical connector assembly, and makes the electrical connector assembly more adapted to application situations where a space is constrained.

Exemplary, each conductive terminal 1 may be formed by stamping and bending a metal sheet. That the conductive terminal 1 is formed by stamping and bending the metal sheet not only may promote producing efficiency and lower manufacturing cost, but also may be helpful to ensure precision and consistency of the conductive terminal 1.

Referring to FIG. 6, exemplary, the first connecting portions 11 of the conductive terminals 1 may be arranged as three rows, the three rows include two first connecting portions 11 which are respectively positioned at two sides and each are in form of flat plate shape and multiple first connecting portions 11 which are positioned in a middle and each are in form of needle shape.

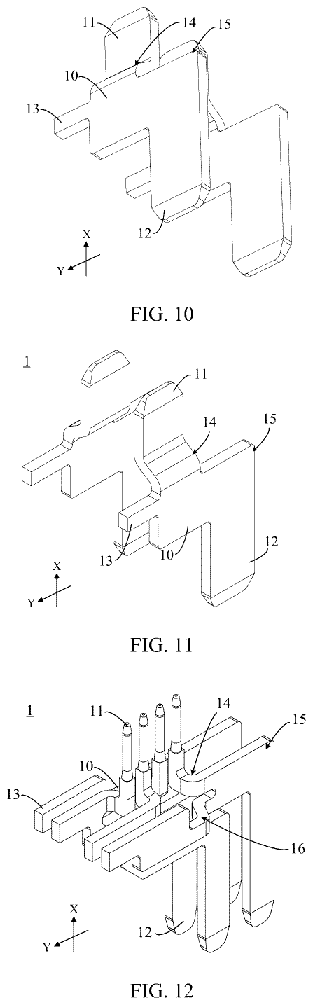

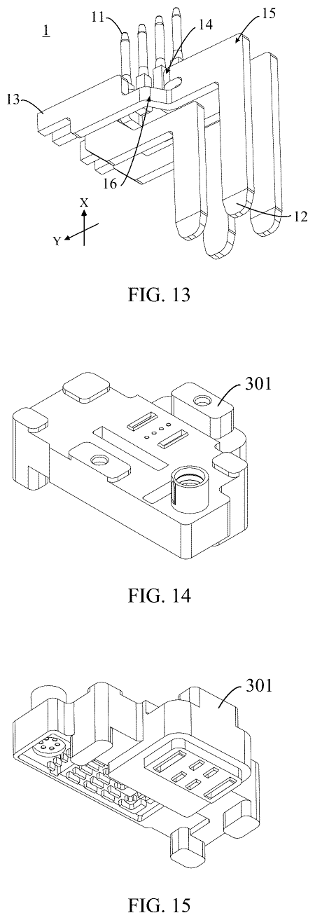

For example, as shown in FIG. 6, in the six conductive terminals 1 which are distributed to be spaced apart from each other, the two first connecting portions 11 of the two conductive terminals 1 which are respectively positioned to the two outer sides each are in form of flat plate shape which extends upwardly and is wide and large, the two conductive terminals 1 each may act as a power terminal for transmission of high current (as shown in FIG. 10 and FIG. 11). The four first connecting portions 11 of the four conductive terminals 1 which are distributed between and spaced apart from the two aforementioned flat plate shape conductive terminals 1 each are in form of needle shape which vertically extends upwardly, the four conductive terminals 1 each may act as a signal terminal for transmission of a signal (as shown in FIG. 12 and FIG. 13). That the first connecting portions 11 of the six conductive terminals 1 are arranged as such may make a layout of the six conductive terminals 1 more compact, and thus sufficiently save a space.

As shown in FIG. 7, the two second connecting portions 12 of the two conductive terminals 1 which are respectively positioned to the two outer sides each are in form of flat plate shape which extends downwardly and is wide and large, and the four second connecting portions 12 of the four conductive terminals 1 which are arranged in the middle each are in form of flat plate shape which is relatively narrow and small, and are arranged as two rows in which each row has the two second connecting portions 12.

Continuously referring to FIG. 12 and FIG. 13, exemplary, the conductive terminal 1 may further include a third bending portion 16. The third connecting portion 13 may be connected with the main body 10 via the third bending portion 16.

In the electrical connector assembly provided by the above embodiment, the third connecting portion 13 is connected with the main body 10 via the third bending portion 16, the conductive terminals 1 form a multi-layer structure by means of the third bending portions 16, and are arranged more tightly in a limited space, which further reduces the space occupied by the conductive terminals 1, is beneficial to the miniaturization design of the electrical connector assembly, and makes the electrical connector assembly more adapted to the application situations where a space is constrained.

An embodiment of the present disclosure does not specifically limit a constituent material of the conductive terminal 1. As an example, the constituent material of the conductive terminal 1 may include a metal material and/or an alloy material, for example a copper alloy. The conductive terminal 1 manufactured by the copper alloy may make the conductive terminal 1 have excellent conductivity and good mechanical strength.

In an embodiment of the present disclosure, the first electrical connector 21 may be a power unit connector (for example a main power connector), the second electrical connector 22 may be a battery unit connector (also be referred to as a battery connector), the third electrical connector 23 may be a vehicle control unit (VCU) connector, but the present disclosure is not limited thereto. Correspondingly, the first connecting portions 11 may act as a mating portion of the power unit connector, that is, the aforementioned first mating portion; the second connecting portions 12 may act as a mating portion of the battery unit connector, that is, the aforementioned second mating portion; and the third connecting portions 13 may be electrically connected with contacting terminals of the corresponding vehicle control unit connector respectively.

An embodiment of the present disclosure does not specifically limit a material of the contacting terminal 231 of the third electrical connector 23. Exemplary, a constituent material of the contacting terminal 231 may include a metal material and/or an alloy material.

Continuously referring to FIG. 1 to FIG. 5, exemplary, the insulative housing 3 may include a first side and a second side which are opposite to each other. Exemplary, the first side of the insulative housing 3 may be a side where a top surface of the insulative housing 3 is located, and the second side of the insulative housing 3 may be a side where a bottom surface of the insulative housing 3 is located.

In the electrical connector assembly of the above embodiment, the first electrical connector 21 may be provided to the first side of the insulative housing 3, and the second electrical connector 22 may be provided to the second side of the insulative housing 3. Wherein, the first connecting portion 11 of the conductive terminal 1 extends toward the first side of the insulative housing 3, which may be understood in combination with FIG. 1 to FIG. 6; and the second connecting portion 12 extends toward the second side of the insulative housing 3, which may be understood in combination with FIG. 1 to FIG. 6. Exemplary, the first connecting portion 11 may extend upwardly from the top surface of the insulative housing 3, and the second connecting portion 12 may extend downwardly from the bottom surface of the insulative housing 3.

In the above embodiment, by that the first electrical connector 21 and the second electrical connector 22 are respectively be provided to an upper side and a lower side of the insulative housing 3 and the first connecting portion 11 and the second connecting portion 12 of the conductive terminal 1 respectively extend toward the corresponding sides of the insulative housing 3, reasonable space allocation may be realized, the entire electrical connector assembly is more compact.

As an example, the third connecting portions 13 each may extend along a horizontal direction and the third connecting portions 13 are arranged as one row.

In the above embodiment, that the third connecting portions 13 of the conductive terminals 1 are arranged as one row may make the third connecting portions 13 more conveniently connected to the contacting terminals 231 of the third electrical connector 23, and may further promote connecting reliability of the electrical connector assembly. Such an arrangement manner further facilitates automatic fitting, is helpful to promote connecting efficiency, and lower labor cost.

Continuously referring to FIG. 6, exemplary, the electrical connector assembly may further include a conductive structure.

In the electrical connector assembly of the above embodiment, the contacting terminals 231 of the third electrical connector 23 may be electrically connected with the third connecting portions 13 of the conductive terminals 1 in one-to-one correspondence via the conductive structure.

In the above embodiment, by that the conductive structure is additionally provided, it can provide one longer electrical connection path, to facilitate arrangement of the third electrical connector 23 which is spaced farther away from the first electrical connector 21 and the second electrical connector 22. Wherein, the conductive structure can provide one stable electrical connection path, reduce the number of connected points, and thus lower risk that problems, such as poor contact, electrical fault and the like, of the electrical connector assembly occur.

Continuously referring to FIG. 6, exemplary, the contacting terminal 231 of the third electrical connector 23 may extend toward the first side of the insulative housing 3. That is to say, the contacting terminal 231 of the third electrical connector 23 and the first connecting portion 11 are the same in extending direction. And the third connecting portion 13 of the conductive terminal 1 may extend perpendicular to the first side and the second side.

The above embodiment further optimizes an internal layout of the electrical connector assembly, reduces the entire thickness of the electrical connector assembly, and makes the electrical connector assembly more adapted to the application situations where a space is constrained. At the same time, the above embodiment employs a design of extending perpendicularly is further beneficial to increase mechanical strength of connected points, and promotes use reliability of the electrical connector assembly.

Continuously referring to FIG. 6, an embodiment of the present disclosure does not specifically limit an implementing manner of the conductive structure. As an example, the conductive structure may include but may not be limited to one or more of a flexible circuit board, a printed circuit board or a metal busbar.

Exemplary, one end of the conductive structure is electrically connected to the conductive terminals 1 of the first electrical connector 21, and the other end of the conductive structure is electrically connected to the contacting terminals 231 of the third electrical connector 23.

As an example, as shown in FIG. 6, the conductive structure may include a bending section 40, a longitudinal extending section 41 and a transverse extending section 42; specifically, the longitudinal extending section 41, the bending section 40 and the transverse extending section 42 are sequentially connected with each other.

Exemplary, the insulative housing 3 may formed by one-shot or multi-shot injection molding process, and an insert molding process may fix the plurality of contacting terminals 231 and the plurality of conductive terminals 1 on the insulative housing 3.

Exemplary, the insulative housing 3 may form a mating wall portion 3A which corresponds to an outer periphery of the first connecting portions 11 of the plurality of conductive terminals 1 and protrudes toward the first side and may form a plurality of positioning protrusions 3B, which protrude, at the second side.

In the above embodiment, the insulative housing 3 is formed with the mating wall portion 3A which protrudes toward the first side and the plurality of positioning protrusions 3B which protrude at the second side, which may facilitate smoothly mating with another mating electrical connector, in turn prevent the plurality of conductive terminals 1 and the plurality of contacting terminals 231 from being misaligned and loosened, further promote the connecting stability of the electrical connector assembly.

Exemplary, the insulative housing 3 may be formed by a first molding body 301 and a second molding body 302 which are engaging with each other.

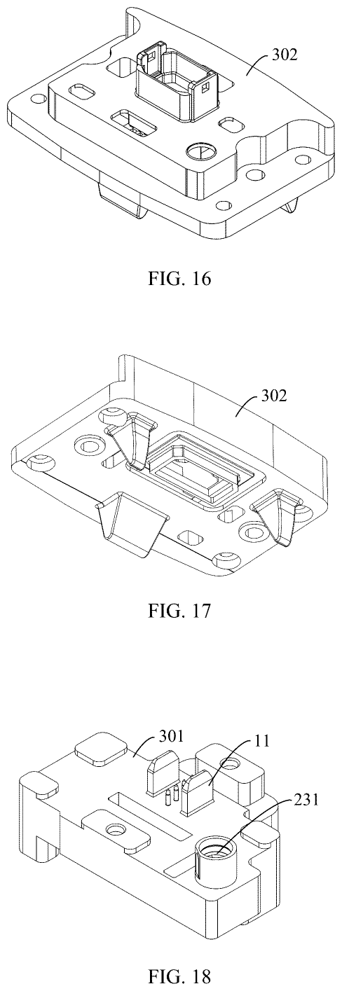

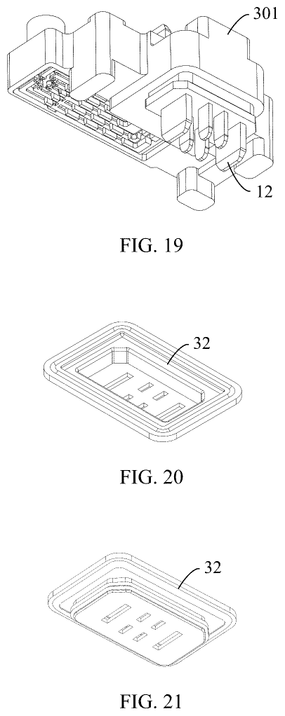

A manufacturing process of the above insulative housing 3 specifically may include a first insert molding stage and a second molding stage. Wherein, in the first insert molding stage, the plurality of conductive terminals 1 and the plurality of contacting terminals 231 are inserted and then a molten plastic is injected, the first molding body 301 as shown in FIG. 14 to FIG. 15 may be manufactured, then the conductive structure is mounted and is welded to the plurality of conductive terminals 1 and the plurality of contacting terminals 231, so that a combination as shown in FIG. 18 to FIG. 19 is obtained. Then the second molding stage is performed, the second molding body 302 is formed as shown in FIG. 16 to FIG. 17 at an outer side of the first molding body 301, so that the electrical connector assembly as shown in FIG. 1 to FIG. 2 is obtained. After the second molding stage, sealing protective material (for example a flexible or better protective material, such as a flexible plastic or rubber) may be used to cover or fill a specific part of this basic structure, so as to provide better waterproof, dustproof, anti-vibration performances.

An embodiment of the present disclosure does not specifically limit a constituent material of the insulative housing 3. As an example, the insulative housing 3 may be made of an engineering plastic material, for example poly(hexamethylene terephthalate) (PA6T), Poly(butylene terephthalate) (PBT) and the like.

As an example, the insulative housing 3 may be provided with a receiving cavity 31 inside the mating wall portion 3A, the receiving cavity is used to receive the first connecting portions 11 of the conductive terminals 1.

Exemplary, referring to FIG. 20 to FIG. 21, the insulative housing 3 may be provided with a sealing element 32, the sealing element 32 may effectively prevent external circumstance factor, such as dust, water and the like, from invading, protect internal structures of the electrical connector assembly, and prolong service life of the electrical connector assembly. At the same time, the design of the sealing element 32 may further promote a protection level of the electrical connector assembly, and enhance adaptability of the electrical connector assembly in a severe environment.

As an example, the sealing element 32 may be formed by a sealing adhesive, and the sealing adhesive may include but may not be limited to a UV adhesive and a silicone adhesive. Referring to FIG. 2 together with reference to FIG. 20 to FIG. 21, exemplary, the sealing element 32 may be provided to a bottom of the insulative housing 3, the sealing element 32 is provided with at least one through hole 321 which allows the second connecting portion 12 to pass therethrough and seal the second connecting portion 12.

When the electrical connector assembly of the above embodiment and another electrical connector (not shown) mate with each other, the sealing element 32 may seal an engagement position therebetween.

An embodiment of the present disclosure does not specifically limit the number of the conductive terminals 1 of the electrical connector assembly, the number of the conductive terminals 1 may be adaptively adjusted according to specifications of the first electrical connector 21, the second electrical connector 22 and the third electrical connector 23.

As shown in FIG. 6, the six conductive terminals 1 are provided and are distributed to be spaced apart from each other, each conductive terminal 1 has three connecting portions (the first connecting portion 11, the second connecting portion 12 and the third connecting portion 13). The third electrical connector 23 has the six contacting terminals 231 which may be electrically connected with the respective third connecting portions 13 of the six conductive terminals 1 in one-to-one correspondence via the conductive structure.

It may be understood that, because it is exemplary that the contacting terminals 231 of the third electrical connector 23 are electrically connected with the third connecting portions 13 of the conductive terminals 1 via the conductive structure, a form of the conductive structure may be adaptively provided according to the number of the conductive terminals 1.

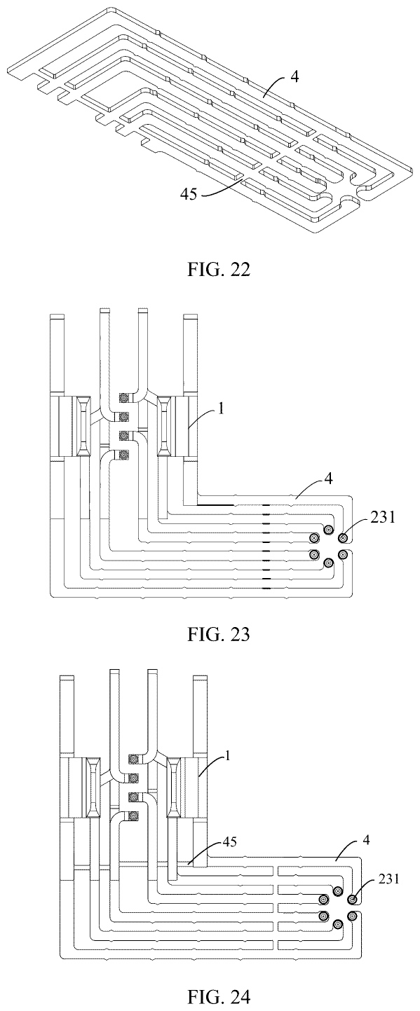

Exemplary, as shown in FIG. 22 to FIG. 24, the conductive structure may include six metal busbars 4, the six metal busbars 4 may be connected with the six contacting terminals 231 in one-to-one correspondence. The six metal busbars 4 specifically may be connected to a metal carrier via a coupling portion 45, after welding, the coupling portion 45 is cut away, the six metal busbars 4 which are independent from each other are obtained.

The above may be understood in combination with FIG. 6 and FIG. 23, wherein, the three-dimensional structure of the conductive terminal 1 may refer to the description of the aforementioned embodiments.

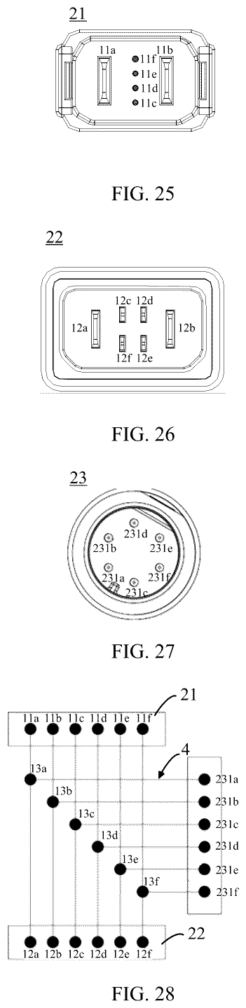

Referring to FIG. 25 to FIG. 28, as an example, the first mating portion of the first electrical connector 21 includes the six first connecting portions 11a, 11b, 11c, 11d, 11e and 11f, which are arranged as three rows, the three rows include the two first connecting portions 11a and 11b which are respectively positioned at two sides and each are in form of flat plate shape and the four first connecting portions 11c, 11d, 11e and 11f which are positioned in a middle, are arranged as one row and each are in form of needle shape. The second mating portion of the second electrical connector 22 includes the six second connecting portions 12a, 12b, 12c, 12d, 12e and 12f, the third mating portion of the third electrical connector 23 includes the six contacting terminals 231a, 231b, 231c, 231d, 231e and 231f which are arranged along a circle, and are electrically connected with the third connecting portions 13a, 13b, 13c, 13d, 13e and 13f of the six conductive terminals 1 in one-to-one correspondence.

The six first connecting portions 11, the six second connecting portions 12 and the six contacting terminals 231 may be electrically connected together via the conductive structure as shown in FIG. 28.

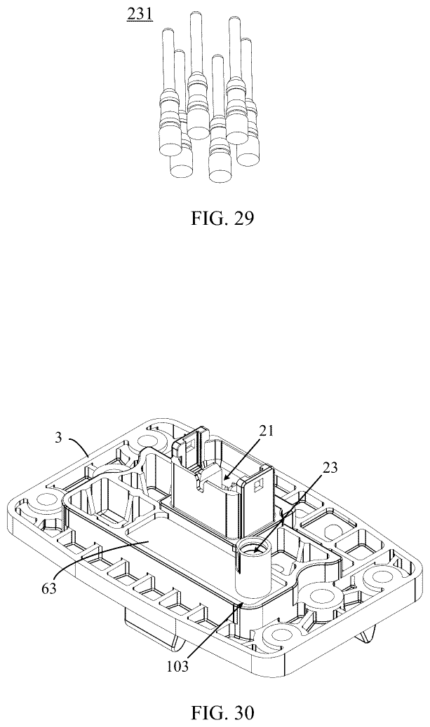

An embodiment of the present disclosure also does not specifically limit a form of the contacting terminal 231 of the third electrical connector 23. As an example, as shown in FIG. 29, the contacting terminal 231 may be a cylindrical metal terminal, and has an outer diameter which is small in an upper part and is large in a lower part.

Hereinafter a second embodiment of the present disclosure will be understood with reference to FIG. 30 to FIG. 42.

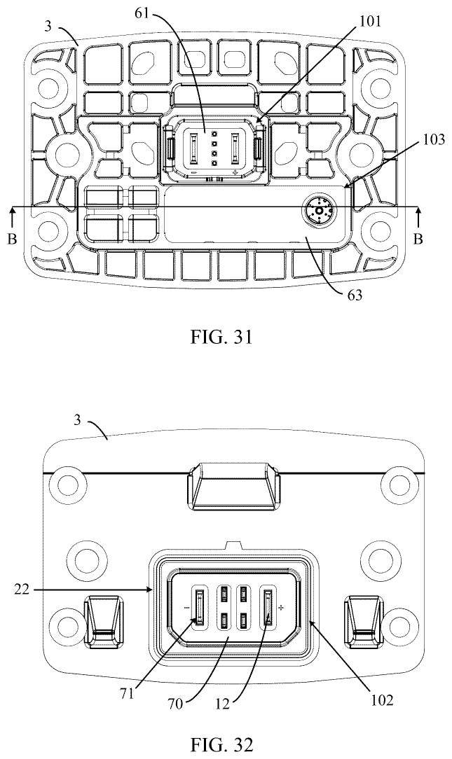

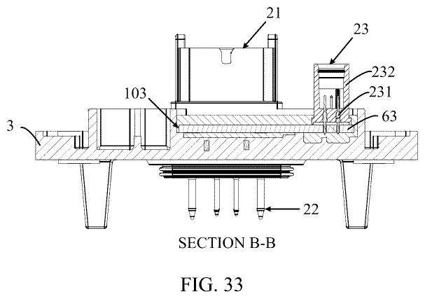

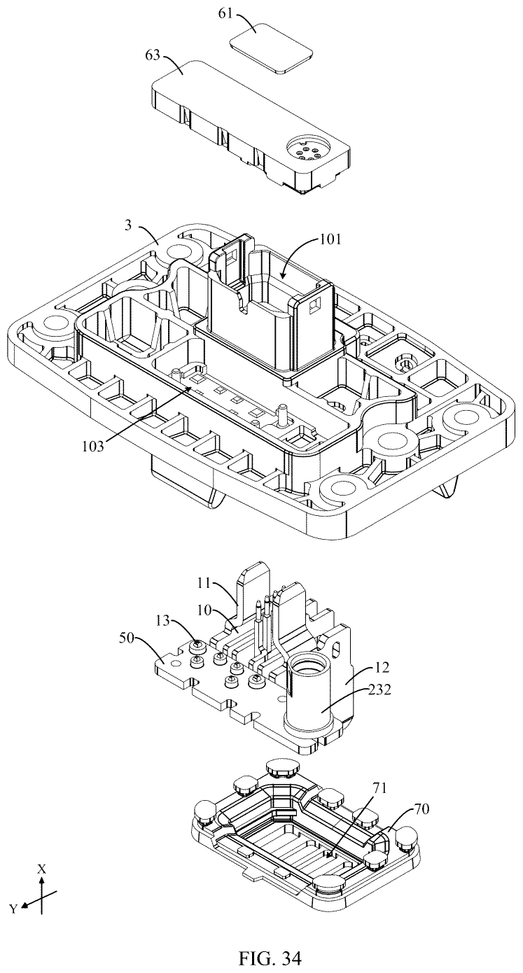

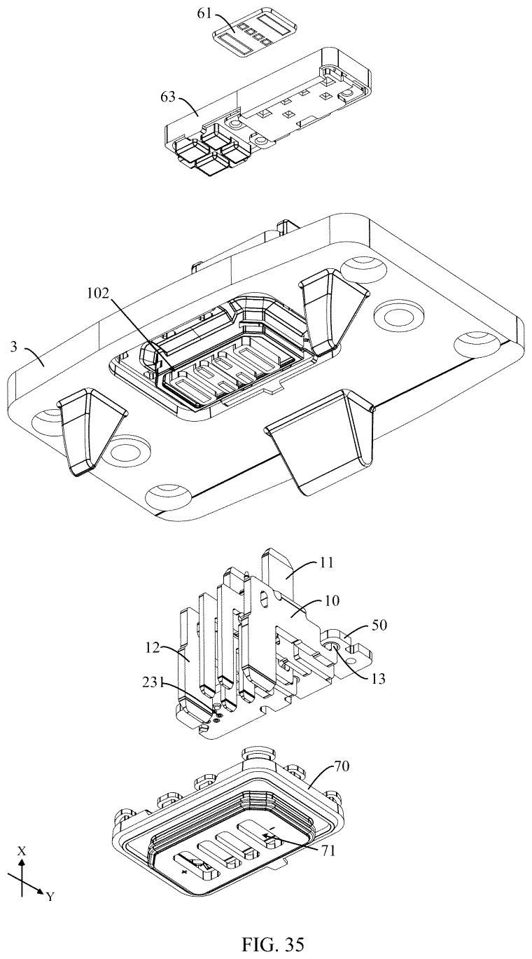

FIG. 30 is a perspective structure schematic view of an electrical connector assembly provided by the second embodiment of the present disclosure; FIG. 31 is a top view of the electrical connector assembly of FIG. 30; FIG. 32 is a bottom view of the electrical connector assembly of FIG. 30; FIG. 33 is a cross-sectional view taken along a line B-B of FIG. 31; FIG. 34 is an exploded view of the electrical connector assembly of FIG. 30 viewed from a first angle; FIG. 35 is an exploded view of the electrical connector assembly of FIG. 30 viewed from a second angle.

It is noted that, a main difference of the second embodiment of the present disclosure with the first embodiment lies in that an implementing manner of the conductive structure is different.

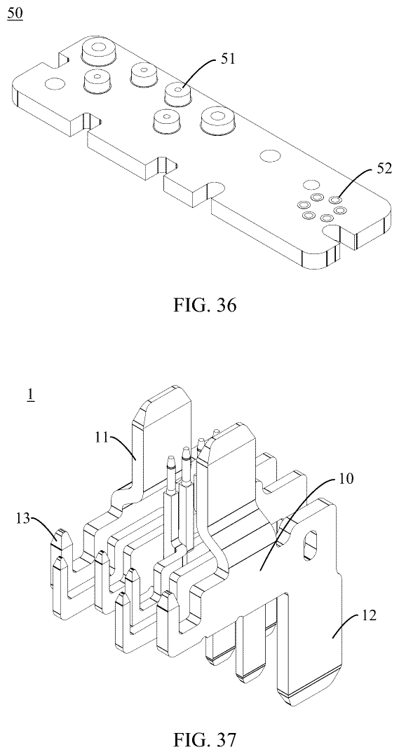

Referring to FIG. 36 to FIG. 39, in the second embodiment, the conductive structure may be a circuit board, the present embodiment is described by taking a printed circuit board (PCB) 50 as shown in FIG. 36 as an example, and also may be a flexible circuit board in other embodiments.

Taking the conductive terminal 1 as shown in FIG. 37 as an example, the third connecting portions 13 of the conductive terminals 1 may be electrically connected with the contacting terminals 231 of at least one third electrical connector 23 via the printed circuit board 50 as shown in FIG. 36.

In the above embodiment, the third connecting portion 13 is realized to be electrically connected with the contacting terminal 231 of the third electrical connector 23 via the printed circuit board 50, which sufficiently utilizes conductive passageways and a wiring structure of the printed circuit board 50, makes the entire structure of the electrical connector assembly more compact, is helpful to reduce internal wiring length and space occupation, and thus further promote integration level, at the same time provides convenience for assembling.

And, by means of wiring capability of the printed circuit board 50, the electrical connector assembly may further flexibly connect the third connecting portions 13 with one or more third electrical connectors 23 according to application requirement, also may connect the third connecting portion 13 with other electrical connector or function module, wherein the third connecting portions 13 of one or more of the conductive terminals 1 also may not be electrically connected with the contacting terminal 231 of the third electrical connector 23, so that expansion of more functions is realized to facilitate meeting working requirements in different application situations.

Exemplary, as shown in FIG. 37, a tail of the third connecting portion 13 away from the main body 10 is in form of needle shape.

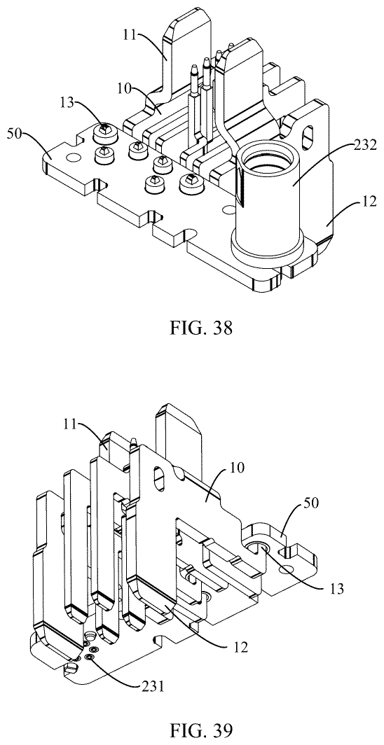

As shown in FIG. 36, the printed circuit board 50 may be provided with first conductive through holes 51 which match with the tails of the third connecting portions 13; understanding in combination with FIG. 38 and FIG. 39, the tails of the third connecting portions 13 may correspondingly insert into the first conductive through holes 51 of the printed circuit board 50.

In the above example, the tail of the third connecting portion 13 is designed as a needle shape and tightly fits with the first conductive through hole 51 of the printed circuit board 50 can provide higher connecting stability, prevent connection from being loosened, and thus ensure stable electrical connection over a long time. That the tail with the needle shape is connected with the first conductive through hole 51 by soldering is simpler and is easily implemented, in comparison with laser welding, does not need high precision alignment and complex device, and is higher in efficiency, is beneficial to lower produce difficulty and promotes fitting efficiency.

Exemplary, the third connecting portion 13 of the conductive terminal 1 may extend toward the first side of the insulative housing 3.

Referring to FIG. 38 and FIG. 39, exemplary, the first connecting portion 11 of the conductive terminals 1 may be arranged as three rows, the three rows include two first connecting portions 11 which are respectively positioned at two sides and each are in form of flat plate shape and multiple first connecting portions 11 which are positioned in a middle and each are in form of needle shape.

That the first connecting portions 11 at the two sides each are designed as the flat plate shape facilitates meeting high current transmission requirement, that the first connecting portions 11 in the middle each are designed as the needle shape is adapted to low current transmission.

For example, as shown in FIG. 38, in the six conductive terminals 1 which are distributed to be spaced apart from each other, the two first connecting portions 11 of the two conductive terminals 1 at the outer sides each are a flat plate shape which extends upwardly and is wide and large, the two conductive terminals 1 may act as power terminals for high current transmission. The first connecting portions 11 of the four conductive terminals 1 which are distributed between and spaced apart from the aforementioned two conductive terminals 1 each are a needle shape which upwardly extends vertically, the four conductive terminals 1 may act as signal terminals for signal transmission. The first connecting portions 11 of the six conductive terminals 1 arranged as such may make a layout of the conductive terminal 1 more compact, and thus sufficiently save space.

Referring to FIG. 38 and FIG. 39, exemplary, the second connecting portions 12 of the conductive terminals 1 each may be in form of flat plate shape so as to facilitate meeting high current transmission requirement.

For example, as shown in FIG. 39, the second connecting portions 12 of the two conductive terminals 1 at the two outer sides each are a flat plate shape which extends downwardly and is wide and large, and the second connecting portions 12 of the four conductive terminals 1 arranged in the middle each are a flat plate shape which is relatively narrow and small, are arranged as two rows, each row has the two second connecting portions 12.

In the above example, that different terminal shapes are combined as such not only makes the layout of the conductive terminals 1 more compact, but also sufficiently saves space, and realizes high efficient space utilization.

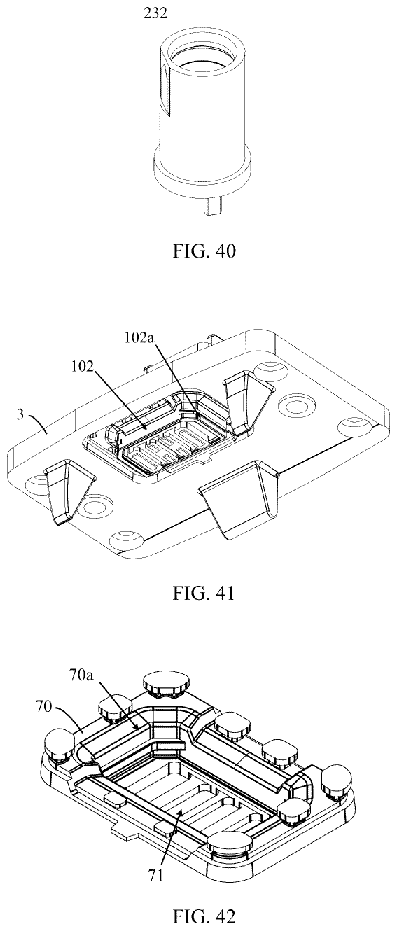

Continuously referring to FIG. 38, exemplary, the third electrical connector 23 may include a mating housing 232 as shown in FIG. 40, the plurality of contacting terminals 231 are fixed in the mating housing 232; tail portions of the contacting terminals 231 are correspondingly connected to the printed circuit board 50.

In the above example, the mating housing 232 and the insulative housing 3 are designed as components which are independent from each other, in comparison with the first embodiment, in the second embodiment, the mating housing 232 of the third electrical connector 23 and the plurality of contacting terminals 231 fixed in the mating housing 232 may be integrally mounted and welded to the printed circuit board 50, which is thus helpful to promote assembling efficiency.

As shown in FIG. 36, the printed circuit board 50 may be further provided with second conductive through holes 52 which match with the plurality of contacting terminals 231, tail portions of the contacting terminals 231 as shown in FIG. 39 may correspondingly connected in the second conductive through holes 52 of the printed circuit board 50. Exemplary, the third connecting portions 13 of the plurality of conductive terminals 1 may be connected to the printed circuit board 50 by Surface-Mount Technology (SMT).

And, the insulative housing 3 is molded by one-shot inject molding process and the plurality of conductive terminals 1 are engaged with the insulative housing 3 at the same time, which further simplifies a producing procedure, reduces producing steps and device using, and is beneficial to lower producing cost.

Continuously referring to FIG. 34, in some embodiments, the insulative housing 3 has a receiving groove 103. Exemplary, the insulative housing 3 is provided with the receiving groove 103 in which a peripheral edge extends upwardly (for example in the positive direction of the X direction of FIG. 34) and a middle is recessed downwardly. Wherein, the third connecting portion 13 extends upwardly from the receiving groove 103, the printed circuit board 50 and the third electrical connector 23 are mounted downwardly in the receiving groove 103.

Exemplary, the third connecting portion 13 may be welded to the printed circuit board 50 by through-hole welding, so as to ensure connecting stability and reliability of the third connecting portion 13. The receiving groove 103 may be filled therein with a third sealing adhesive 63 which provides waterproof sealing for the printed circuit board 50 and the third connecting portions 13.

Continuously referring to FIG. 34, in some embodiments, the first side of the insulative housing 3 is further provided with a first electrical connector interface 101. Exemplary, the first side of the insulative housing 3 is provided with the first electrical connector interface 101 in which a peripheral edge extends upwardly, and a middle is recessed downwardly.

The first connecting portions 11 of the conductive terminals 1 are provided in the first electrical connector interface 101, and the first electrical connector interface 101 may be filled therein with a first sealing adhesive 61.

In the above example, by that the first electrical connector interface 101 and the receiving groove 103 are filled therein with the sealing adhesives 61 and 63, tiny gaps between each connecting portion 11,13 of the conductive terminal 1 and the insulative housing 3 may be effectively filled to form additional waterproof barrier, which is helpful to further promote waterproof performance of the electrical connector assembly, ensures that the electrical connector assembly still can reliably operate in humid or underwater circumstance, so as to conform to IPX7 level or even higher level waterproof standard. And the process to fill the sealing adhesive 61, 63 is relatively simple, is easily implemented, and so does not bring negative effect on high producing efficiency or producing cost.

Referring to FIG. 35, in some embodiments, the insulative housing 3 is further provided with a second electrical connector interface 102 at the second side which opposites the first side, and a sealing ring 70 which is provided to the second electrical connector interface 102. Exemplary, the insulative housing 3 is further provided with the second electrical connector interface 102, which extends downwardly (for example the negative direction of the X direction in FIG. 35), at the second side opposite to the first side.

The sealing ring 70 is provided with penetrating holes 71 which match with the second connecting portions 12 of the conductive terminals 1, the second connecting portions 12 of the conductive terminals 1 correspondingly insert into the penetrating holes 71. Exemplary, the sealing ring 70 is formed on the insulative housing 3 by injection molding process with a plastic material.

In the above example, the sealing ring 70 and the insulative housing 3 employ integral molding design, so that the entire electrical connector assembly can attain higher level (for example IPX7 level) waterproof standard, moreover, further reduce risk that connection is unstable or waterproof performance is lowered due to detaching of the sealing ring 70.

As an example, as shown in FIG. 41, an outer edge of the second electrical connector interface 102 may be provided with a circle of recessed groove 102a. Correspondingly, as shown in FIG. 42, an inner side of the sealing ring 70 is correspondingly provided with a circle of protrusion 70a.

After injection molding of the sealing ring 70 is performed, the protrusion 70a at the inner side may insert into the recessed groove 102a at the outer edge of the second electrical connector interface 102, fixing of the sealing ring 70 is realized by insertion fit, so as to ensure that the sealing ring 70 is firmly and securely mounted on the second electrical connector interface 102, and is not easily detached from the second electrical connector interface 102.

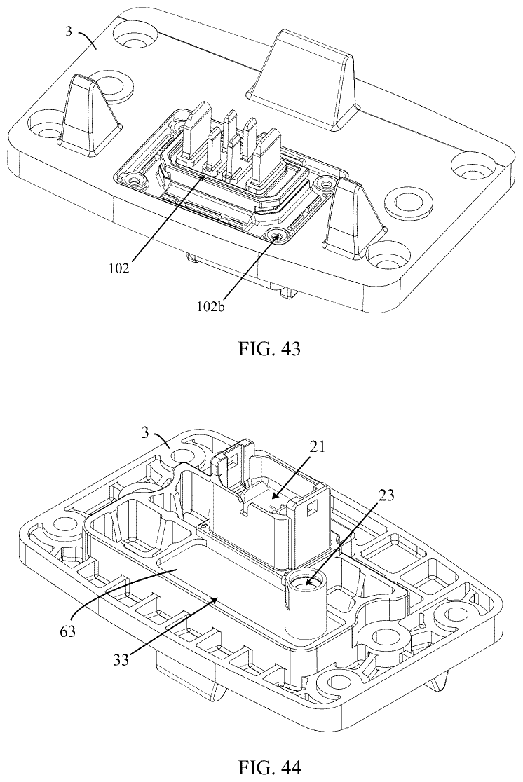

In other possible examples, as shown in FIG. 43 and FIG. 44, the insulative housing 3 is slightly varied, wherein an outer edge of the second electrical connector interface 102 is provided with inserting grooves 102b. The inserting grooves 102b may be filled with a glue therein.

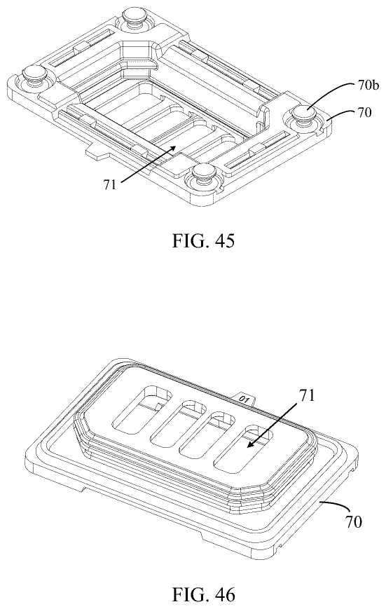

Referring to FIG. 45 and FIG. 46, in the above example, the sealing ring 70 is slightly modified so that a side of the sealing ring 70 toward the insulative housing 3 may be provided with four insertion protruding portions 70b which each like a mushroom head in contour, the insertion protruding portions 70b may correspondingly insert into the inserting grooves 102b. In the present example, the insertion protruding portion 70b may be further adhered to the inserting groove 102b of the insulative housing 3 by the glue, so that the sealing ring 70 is securely mounted to the second electrical connector interface 102.

Specifically, it may be that, the glue enwraps the insertion protruding portion 70b, and adheres the insertion protruding portion 70b into the inserting groove 102b, the glue is cured and become hard to form a hard adhering layer, which can ensure that the sealing ring 70 tightly inserts into the insulative housing 3 and is not detached from the insulative housing 3 over a long-time use.

The above example provides an adhere mounting-type sealing ring design, by adhering of the glue and insert fixing between the insertion protruding portion 70b and the inserting groove 102b, the sealing ring 70 is securely mounted on the insulative housing 3, the insertion protruding portion 70b may make the sealing ring 70 retained stable when subjected to an external force, prevent the sealing ring 70 from being displaced, and thus ensure that the sealing ring 70 is not detached from the insulative housing over a long-time use.

Moreover, the above example not only can further promote sealing performance, in comparison with traditional integral molding process of a sealing ring and a plastic, the above example also reduces dependence on a high precision mold, is lower in the requirement on parts, so further can simplify manufacturing process and lower producing cost.

It is obvious to those skilled in the art that various modifications and changes can be made in the present disclosure without departing from the spirit or scope of the present disclosure. Therefore, the present disclosure is intended to cover modifications and changes of the present disclosure that fall within the scope of the corresponding claims (technical solutions to be claimed for protection) and equivalents thereof. It is noted that implementing manners provided by the embodiments of the present disclosure can be combined with each other without contradiction.

The above embodiments only express several embodiments of the present disclosure, and their descriptions are more specific and detailed, but should not be understood as limiting the scope of the patent disclosure. It should be pointed out that, for ordinary technical personnel in this field, several variations and modifications can be made without departing from the concept of the present disclosure, which are within the scope of protection of the present disclosure. Therefore, the scope of protection of the present disclosure should be based on the appended claims.

What is claimed is:

1. An electrical connector assembly, comprising an insulative housing and a first electrical connector, a second electrical connector and a third electrical connector which are provided on the insulative housing;
wherein the first electrical connector is provided with a plurality of conductive terminals, the third electrical connector is provided with a plurality of contacting terminals, each conductive terminal comprises a main body and a first connecting portion, a second connecting portion and a third connecting portion which extend outwardly from the main body;
wherein the first connecting portions of the conductive terminals act as a first mating portion of the first electrical connector, the second connecting portions of the conductive terminals act as a second mating portion of the second electrical connector, and the third connecting portions of the conductive terminals are electrically connected respectively with the contacting terminals of the third electrical connector.

2. The electrical connector assembly according to claim 1, wherein
the first connecting portion of the conductive terminal extends outwardly from the main body along a first direction,
the second connecting portion extends outwardly from the main body along a second direction,
the third connecting portion extends outwardly from the main body along a third direction;
wherein any two directions of the first direction, the second direction and the third direction are perpendicular to each other.

3. The electrical connector assembly according to claim 2, wherein
each conductive terminal is formed by stamping and bending a metal sheet,
the first connecting portions of the conductive terminals are arranged as three rows, the three rows comprises two first connecting portions which are respectively positioned at two sides and each are in form of flat plate shape and multiple first connecting portions which are positioned in a middle and each are in form of needle shape.

4. The electrical connector assembly according to claim 2, wherein
the third connecting portions of the conductive terminals are arranged as one row.

5. The electrical connector assembly according to claim 1, wherein
the insulative housing comprises a first side and a second side which are opposite to each other,
the first electrical connector is provided to the first side of the insulative housing,
the second electrical connector is provided to the second side of the insulative housing;
the first connecting portion of the conductive terminal extends toward the first side of the insulative housing, and
the second connecting portion extends toward the second side of the insulative housing.

6. The electrical connector assembly according to claim 5, wherein
the electrical connector assembly further comprises a conductive structure;
the contacting terminals of the third electrical connector are electrically connected with the third connecting portions of the conductive terminals in one-to-one correspondence via the conductive structure.

7. The electrical connector assembly according to claim 6, wherein
the contacting terminal of the third electrical connector extends toward the first side of the insulative housing;
the third connecting portion of the conductive terminal extends perpendicular to the first side and the second side.

8. The electrical connector assembly according to claim 6, wherein
the conductive structure is a combination of one or more of a plurality of metal busbars, a flexible circuit board and a printed circuit board;
one end of the conductive structure is electrically connected to the third connecting portions of the conductive terminals, and the other end of the conductive structure is electrically connected to the contacting terminals of the third electrical connector.

9. The electrical connector assembly according to claim 5, wherein
the insulative housing is formed by injection molding, the insulative housing fixes the plurality of contacting terminals and the plurality of conductive terminals thereon;
the insulative housing forms a mating wall portion which corresponds to an outer periphery of the first connecting portions of the plurality of conductive terminals and protrudes toward the first side, and the insulative housing forms a plurality of positioning protrusions which protrudes at the second side.

10. The electrical connector assembly according to claim 9, wherein
the insulative housing is provided with a receiving cavity inside the mating wall portion, the receiving cavity is used to receive the first connecting portions of the conductive terminals;
the insulative housing is provided with a sealing element which is used to seal gaps between the conductive terminals and the receiving cavity.

11. The electrical connector assembly according to claim 1, wherein
the third connecting portions of the conductive terminals are electrically connected with the contacting terminals of the third electrical connector respectively via a circuit board.

12. The electrical connector assembly according to claim 11, wherein
the circuit board is a printed circuit board,
a tail of each third connecting portion away from the main body is in form of needle shape;
the printed circuit board is provided with a plurality of first conductive through holes;
the tails of the third connecting portions correspondingly insert into the first conductive through holes of the printed circuit board.

13. The electrical connector assembly according to claim 11, wherein
the first connecting portions of the conductive terminals are arranged as three rows, the three rows comprises two first connecting portions which are respectively positioned at two sides and each are in form of flat plate shape and multiple first connecting portions which are positioned in a middle and each are in form of needle shape;
the second connecting portions of the conductive terminals each are in the form of flat plate shape.

14. The electrical connector assembly according to claim 11, wherein
the third electrical connector comprises a mating housing,
the contacting terminals are fixed in the mating housing;
tail portions of the contacting terminals are correspondingly connected to the circuit board.

15. The electrical connector assembly according to claim 11, wherein
the insulative housing is provided with a receiving groove;
the third connecting portions of the plurality of conductive terminals are provided in the receiving groove, and
the receiving groove is filled with a third sealing adhesive.

16. The electrical connector assembly according to claim 11, wherein
a first side of the insulative housing is provided with a first electrical connector interface;
the first connecting portions of the conductive terminals are provided in the first electrical connector interface, and
the first electrical connector interface is filled with a first sealing adhesive therein.

17. The electrical connector assembly according to claim 11, wherein
the insulative housing is further provided with a second electrical connector interface at a second side which opposites a first side, and a sealing ring provided to the second electrical connector interface;
the sealing ring is provided with a plurality of penetrating holes,
the second connecting portions of the conductive terminals correspondingly insert into the penetrating holes.

18. The electrical connector assembly according to claim 17, wherein
the sealing ring is formed on the insulative housing by injection molding.

19. The electrical connector assembly according to claim 17, wherein
an outer edge of the second electrical connector interface is provided with an inserting groove;
a side of the sealing ring toward the insulative housing is provided with at least one insertion protruding portion, the insertion protruding portion inserts into the inserting groove, so that the sealing ring is fixed on the second electrical connector interface.
